(19) United States
(12) Patent Application Publication
(10) Pub. No.: US 2008/0153056 A1
(43) Pub. Date: Jun. 26, 2008

(54) Awake airway: mandibular (jaw) thrust feature to enhance a patent airway

(76) Inventor: Charles Craig Baldwin, Coumbia, MD (US)

Correspondence Address: Charles C. Baldwin, 5000 Dustin Court, Columbia, MD, 65203, US

(21) Appl. No.: 11/602,919

(22) Filed: Dec. 22, 2006

(51) Int. Cl. A61C 5/00

(52) U.S. Cl. 433/140

(57) ABSTRACT

The Awake Airway is an oral device designed with two arches to gently hold both the maxillary and mandibular dental arches in a fixed position angled slightly open in such a way as to not stimulate any part of the oral cavity or oropharynx so a fully wide awake user would tolerate it. It would be made of a resilient material such as a soft plastic with a foam insert to hold the teeth or edentulous arches. It is shaped to conform to the teeth and maxillary and mandibular anatomy, and easily inserted by the user him/herself. By gently maintaining the mouth slightly open it would enhance the patency of the airway. The mandibular (jaw) thrust feature capitalizes on the unique anatomy of the human tempormandibular joint wherein anterior (frontal) movement of only a few millimeters changes the joint from a hinge to a cam, and both motions are separate: thus thrusting the mandibular component a mere few millimeters elevates that mandibular condyle, opening the orpharynx without gagging the patient or further opening the mouth, enhancing airway patency. It's usefulness would include that of a clinical airway in awake to sedated or anesthetized or obtunded patients that may be more flexible than currently available airway support devices since it may be tolerated until the user is fully awake. Another use might be in Obstructive Sleep Apnea (OSA) as the patient may place it themselves and tolerate it as they sleep with airway support that could supplement or replace current therapies.

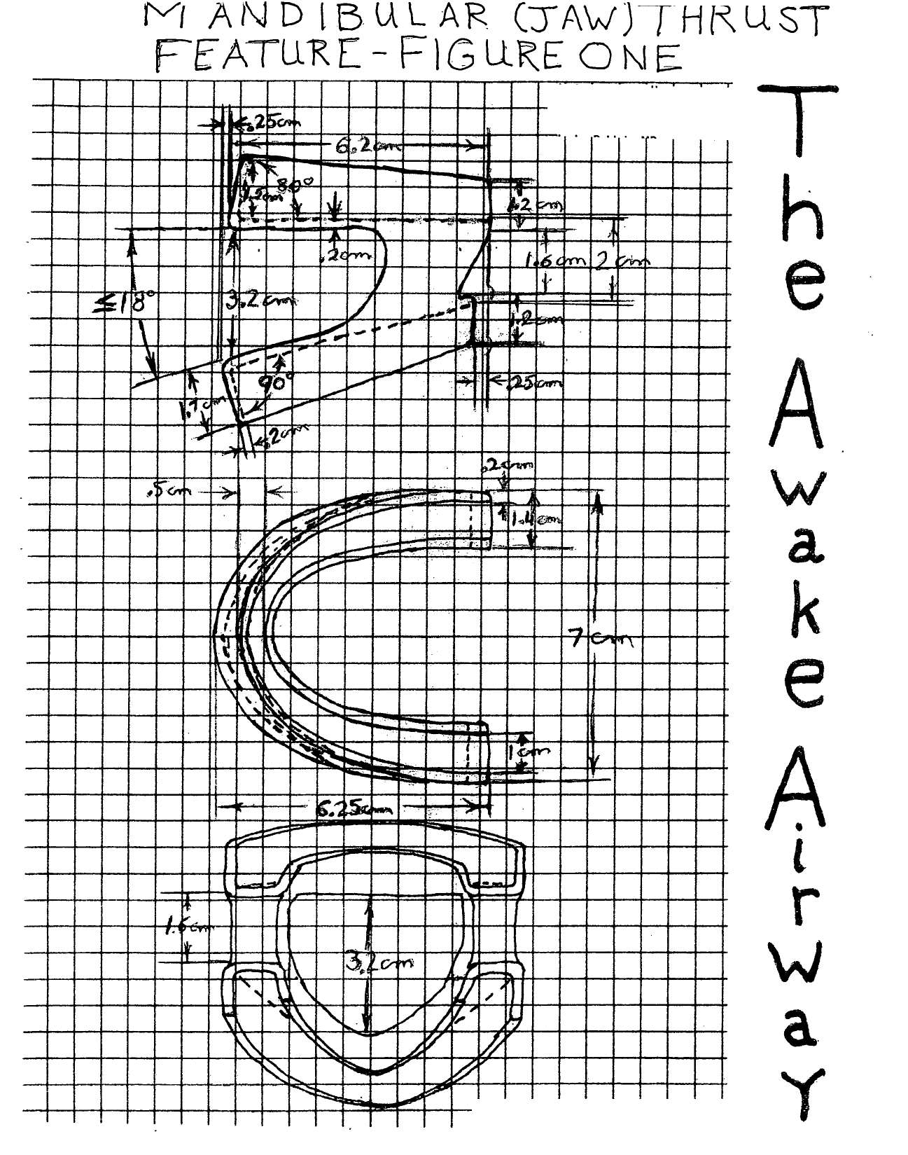

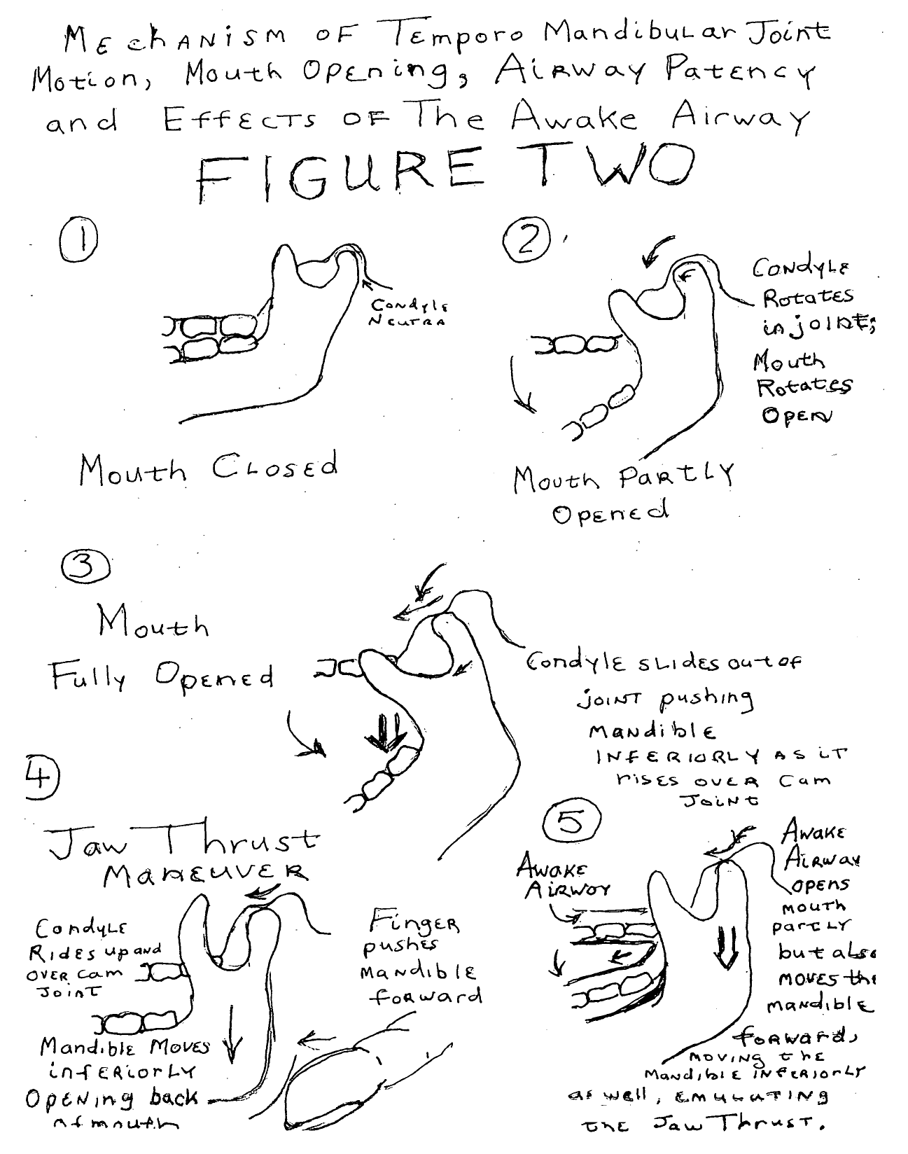

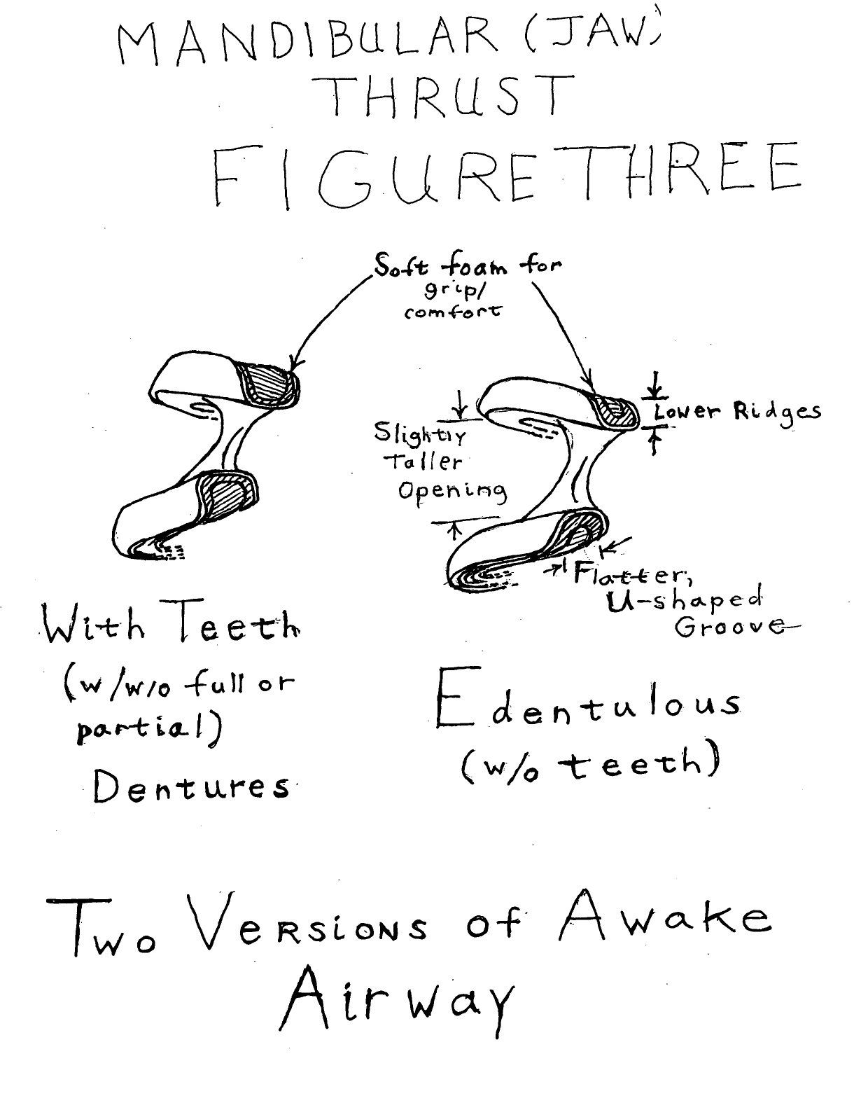

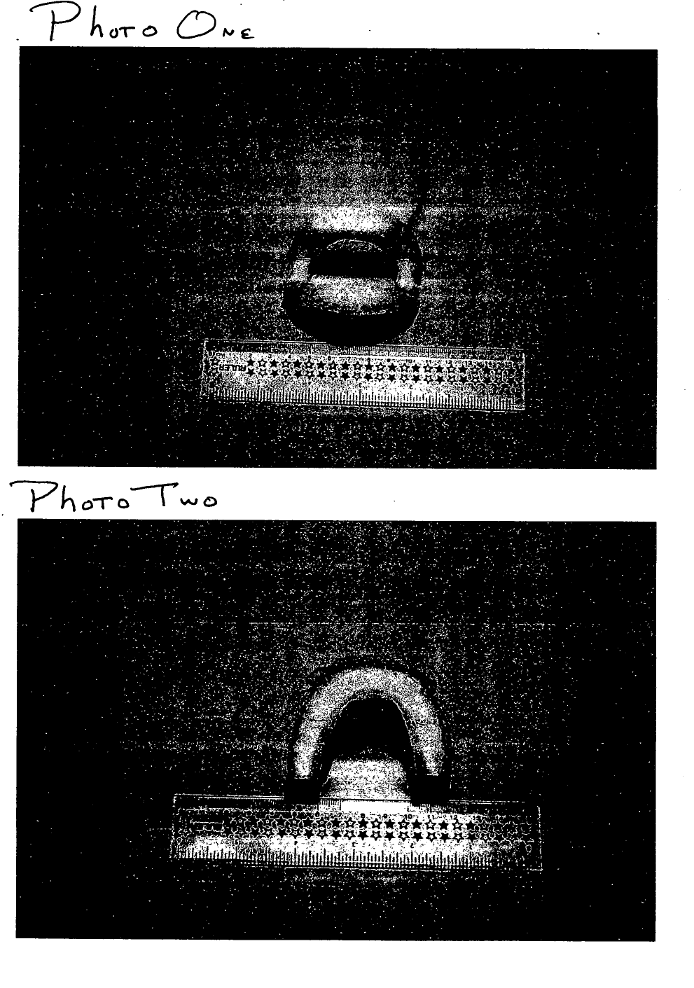

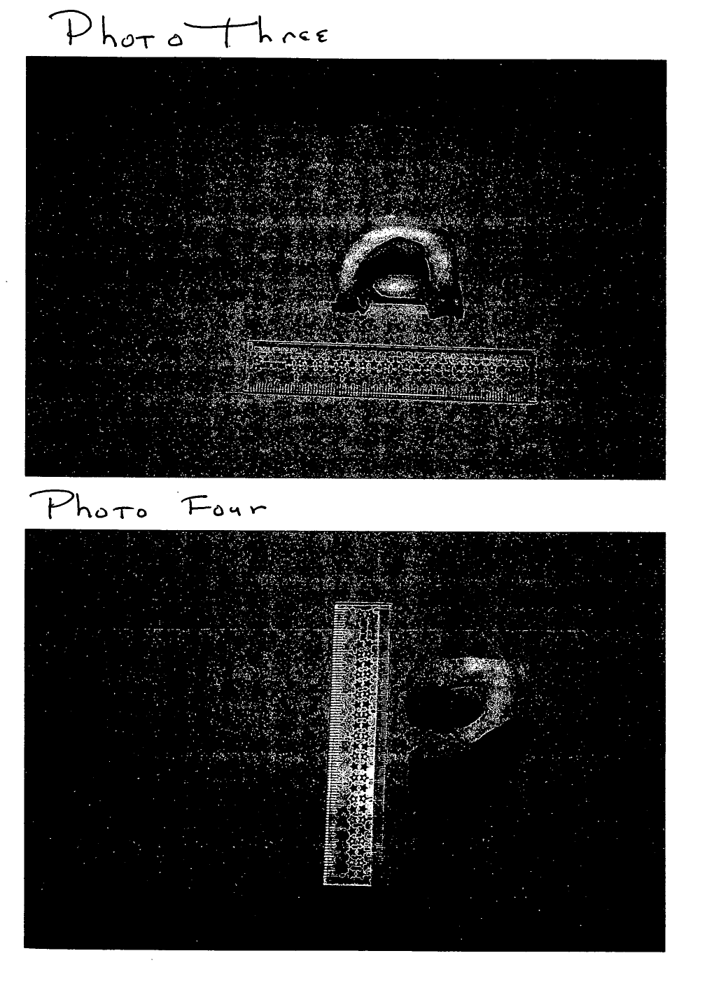

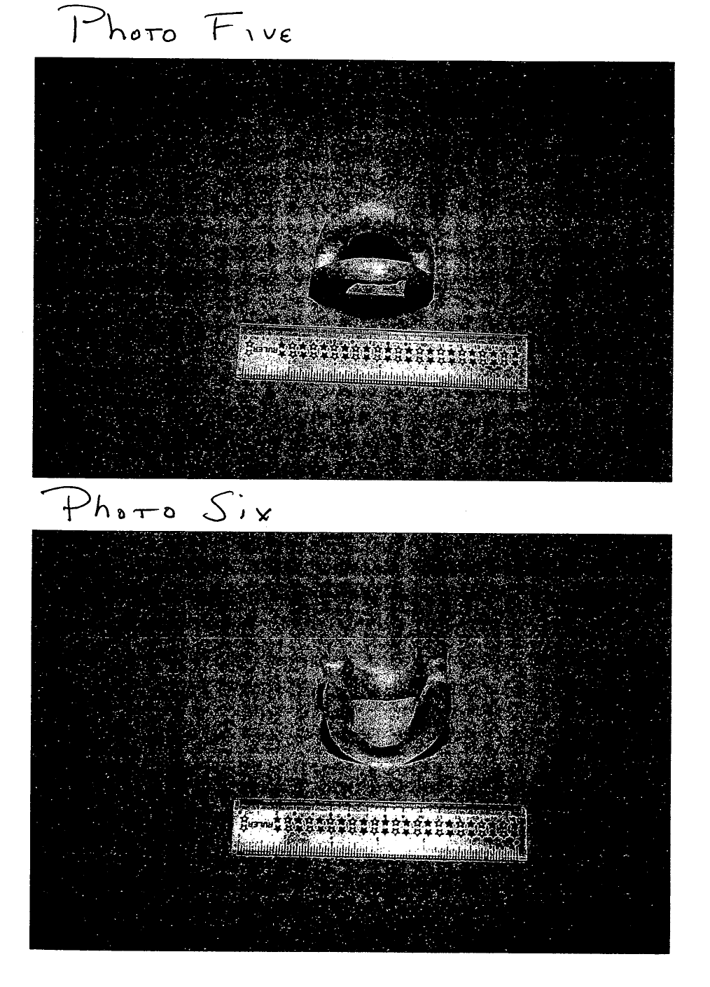

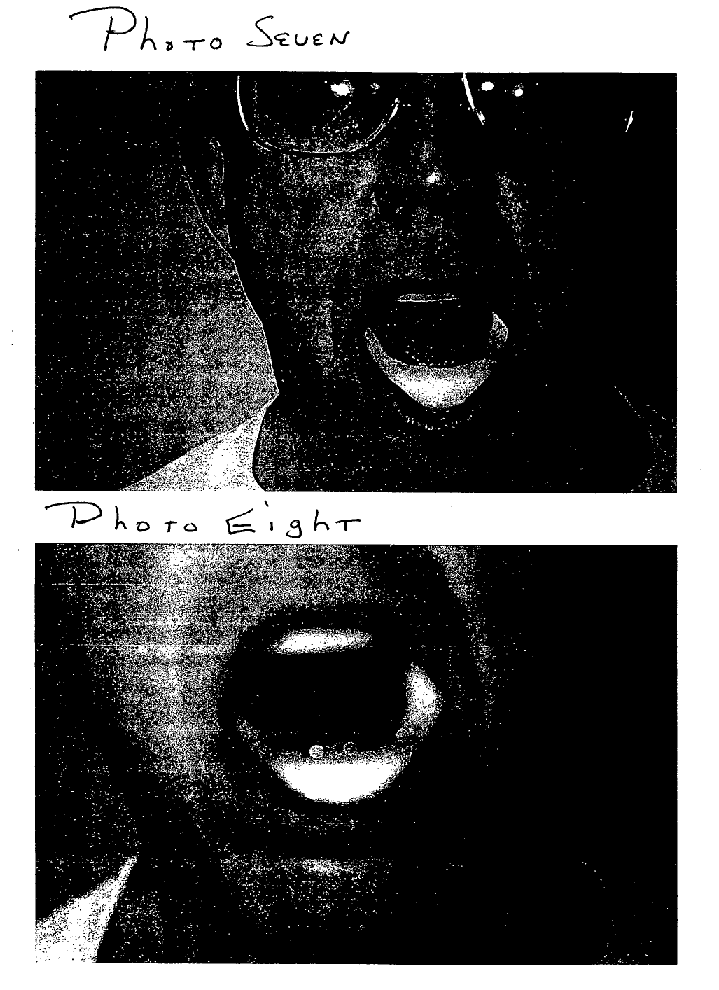

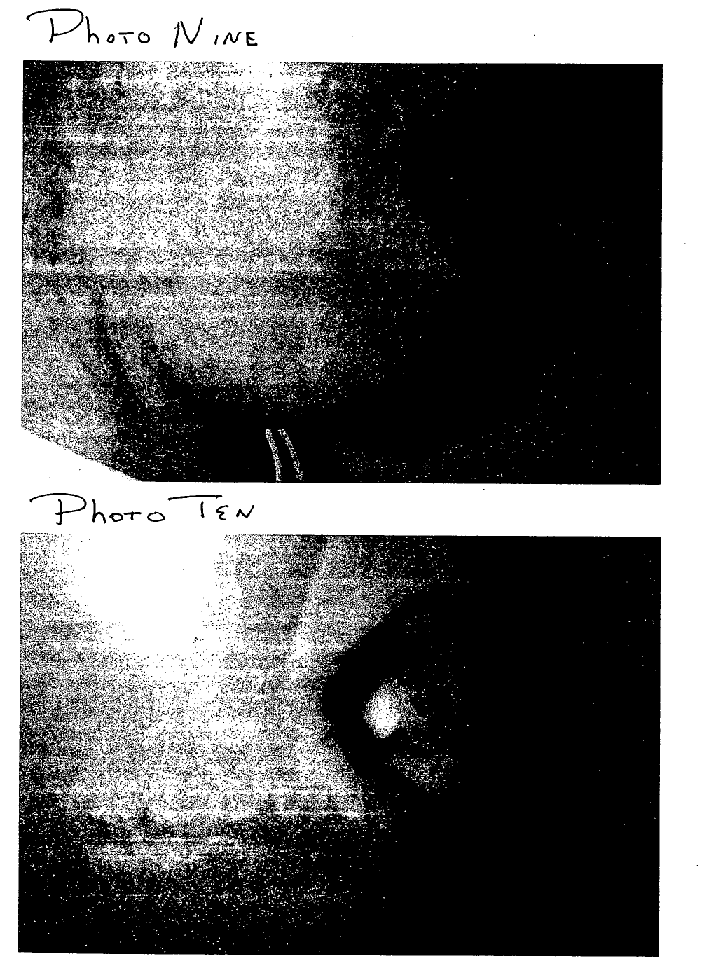

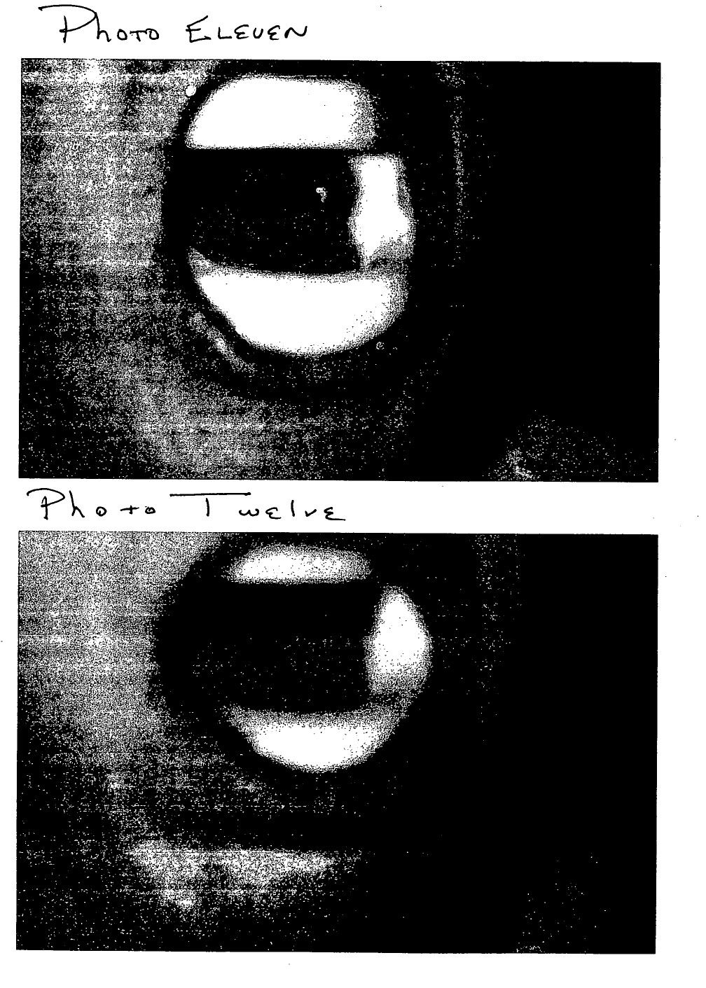

The Awake Airway is an oral device designed to fit of the dental arches or alveolar ridges of both the maxilla and mandible with connecting buttresses. The buttresses maintain an opening between the two arches, establishing a patent oropharynx. It will likely be made of soft plastic with foam components where appropriate. The Awake Airway is designed to be tolerated by a fully awake user with intact cranial nerve reflexes, as described in the utility patent application for it's non-gagging feature. The angle between the two arches likely needs to be less than 20 degrees for comfort, although this angle probably needs to be as wide as comfortably possible for maximum benefit.

To enhance the Awake Airway's usefulness in the sedated or obtunded patient, a design element that anteriorly moves the mandibular arch from one to three millimeters is added. The element takes advantage of the unique structure of the human temporomandibular joint, which is a combination roller hinge joint and a cam joint. An accompanying diagram is attached to visually demonstrate this feature and the Awake Airway's use of it.

For most of its range of motion the human Temporomandibular joint simply angles open like a hinge. As it approaches full opening, however, the mandibluar condyle slides forward over the cartilaginous meniscus of the joint thus riding up a bony prominence like a cam. This significantly opens the posterior portion of the oropharynx further, in a sense slightly dislocating the jaw. Anesthesiologists and other health care providers take advantage of this anatomy pushing the mandible frontally without opening the mouth by placing their thumbs or fingers behind the angle of the mandible and gently thrusting forward, a very effective airway maneuver called the Jaw Thrust.

The Awake Airway emulates this maneuver by gently but firmly holding the dental ridges and slightly pushing the mandibular component forward in relation to maxillary component. No other supportive airway does this. Combined with partially opening the mouth and having the nongagging design feature the Awake Airway may be used in the fully aroused person who then might sleep or be sedated with it in place. Conversely the Awake Airway could be in place with user's level of consciousness altered and left in place as they awaken and return to full arousal, perhaps maintaining a patent airway better than the current available devices. The jaw thrust feature need not have the mouth opened to be effective: indeed in the clinical maneuver it usually results in a competent airway passage via the nasopharynx. Hence the application for a utility patent is made for this feature separate from its nongagging quality.

This feature may make the Awake Airway useful in the management of Obstructive Sleep Apnea (OSA), an increasingly common malady with the rising obesity and aging of the population, in addition to it's likely usefulness as a clinical airway support device in sedating or anesthetizing patients for medical procedures and surgery. Moreover it may have a place in the airway management of the critically ill and those with respiratory and/or ventilatory failure.

The Awake Awake can be made in two versions to accommodate those with full teeth, partial dentures and those who are edentulous (toothless) by making an edentulous version with a slightly taller and wider foam lining in the arches to hold the gums in place and maintain the same height between the maxillary and mandibular components.

Another version with an arch bridging the mandibular component to hold the tongue in place, without gagging the user, is proposed as a variant as well.

Linked Applications This application is linked to three utility patent applications and one desigen patent application:

The design application is for the unique and readily recognizable appearance of the Awake Airway, including all it's variants.

The Three other utility patent applications are:

1) The non-gagging feature of the airway achieved by primarily using the dental arches to stabilize it in the mouth and touching no portion of the oropharynx, tongue or palate that would gag the user, evening it's variants. This allows it's use in the fully awake person with intact cranial nerves.

2) A glossal variant incorporating s tongue arch on the mandibular component to hold the tongue in place without gagging the user, enhancing airway patency, especially in those with large tongues or exceptionally small mouths.

3) A variant with the addition of a manual attachment such as a zip tie to the maxillary arch to anchor the more invasive airways such as endotracheal tubes, enhancing their stability and position.

### Attachments to this Application

Figure One: Design Graphic for a large version for the Awake Airway.

Figure Two: Drawing of the Mechanisms of Motion of the Human Temporomandibular Joint Motion and the Effects of the Awake Airway, emulating the Jaw Thrust Maneuver.

Figure Three: Drawing of two versions of the Awake Airway: With and Without Teeth (edentulous).

Photos One through Six: Photos of a rough large prototype of the awake airway.

Photos Seven through Twelve: The large rough prototype in place in the mouth.

1-53. (canceled)

54. A parabolic arch shaped support to gently and firmly grasp the maxillary dental arch; the support covering from the incisor teeth to the molar teeth or, for the edentulous, the entire maxillary alveolar arch; the support comprised of a resilient and firm material molded into a cross-sectional u-shape; an outside (buccal) edge or lip and inside (lingual) edge or lip comprising the two sides of the cross sectional u-shape, with a softer foam material inserted inside the resilient material

55. A second support arch as claimed in claim 54 to also have a parabolic arch shaped to follow the mandible also having an insert of foam material in the cross-sectional shape with a buccal and lingual lip and floor to gently hold the teeth or alveolar ridges with differing thicknesses to accommodate them

56. The floor or bottom of the cross sectional u shape as claimed in claim 54 for the maxillary arch and in claim 55 for the mandibular arch to be narrow at the peak of the arch to accommodate the incisor teeth, widening toward both legs of the arch, maximum at the edge to accommodate the molar teeth/or wider alveolar ridge.

57. An outside (buccal) lip and an inside (lingual) lip as claimed in claim 54 and in claim 55 to be angled a few degrees (circa 15) degrees) posteriorly from a vertical from the base of the support as claimed in claim 54 and claim 55 and to be sufficiently high to cover the incisor teeth at the apes of the arch.

58. An outside buccal lip and an inside (lingual) lip as claimed in claim 54 and in claim 55 to have the angle from the base of the support approach back to vertical as it is molded toward the molar teeth and to diminish in height to just cover the molar teeth (usually lower than the incisor teeth).

59. An inside (lingual) lip or edge as claimed in claims 57 and 58 to be shorter than the outside (buccal) lip or edge to better conform to the angle of the mucosa arising from the lingual edge of the incisor teeth.

60. An inside (lingual) lip or edge as claimed in claim 54 and claim 55 to taper more that the outside (buccal) lip or edge to accommodate the fuller and flatter angle of the lingual mucosa.

61. A buttress or arch molded in the maxillary support as claimed in claim 54 to be affixed to the mandibular arch support in claim 55 reversed 180 degrees from the maxillary support to gently grasp the mandibular dental arch so as to hold the two arches angled open from one another.

62. The buttress in claim 61 to be molded into the molar portions of the maxillary and mandibular arches, extending forward toward the premolars, and molded not to extend beyond the edge of either the mandibular or maxillary arches so as to have no edges, just a smooth molded surface

63. The buttress or arch as claimed in claim 61 to have an oval to rounded rectangular cross sectional shape at all levels including its attachment to the underside of the alveolar arch support and to angle the two alveolar arch supports to obtain an opening of more than a centimeter and/or an angle of 15 degrees and maintain them in that relationship.

64. Two arch supports as claimed in claim 54 and claim 55 and the buttress or arch as claimed in claim 61 together to gently mold and grasp the maxilla and mandible, whether with teeth or edentulous, and keep the mouth gently but firmly opened without touching any oral or pharyngeal structures that would gag or stimulate the wearer

65. A buttress or arch as claimed in claim 61 and claim 64 that gently advances the mandibular arch forward (frontally) sufficiently to engage the cam joint mechanics of the human Temporo-mandibular joint to open the oropharynx and maintain patency of the airway

66. The buttress or arch as claimed in claim 61 and 64 to have a smooth sigmoid shape from the maxillary to mandibular supports, thereby holding an open angle between the two arches of approximately 15 degrees and a frontal positioning of the mandibular arch vis-à-vis the maxillary arch to position the mandibular condyle over the meniscus of the temporomandulbar joint exploiting its cam mechanics.
